(19) United States
(12) Patent Application Publication
(10) Pub. No.: US 2009/0179487 A1
(43) Pub. Date: Jul. 16, 2009

(54) DISTRIBUTED POWER ARCHITECTURE HAVING CENTRALIZED CONTROL UNIT

(75) Inventor: Chia-Wei Liu, Taoyuan Hsien (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: DELTA ELECTRONICS, INC., Taoyuan Hsien (TW)

(21) Appl. No.: 12/132,691

(22) Filed: Jun. 4, 2008

(30) Foreign Application Priority Data
Jan. 10, 2008 (TW) 097101075

(51) Int. Cl. H02J 1/00

(52) U.S. Cl. 307/31

(57) ABSTRACT

The configurations of a distributed power architecture are provided. The proposed distributed power architecture includes a first converter having a first power stage, a plurality of second converter, each of which has a second power stage and is coupled to the first converter, and a centralized control unit controlling the first converter and the plurality of second converters.

### FIELD OF THE INVENTION

The present invention relates to a distributed power architecture (DPA). More particularly, the present invention relates to a DPA having a centralized control unit.

### BACKGROUND OF THE INVENTION

Nowadays, DPAs are widely used in power source systems. Except providing relatively higher efficiency and reliability for telecommunication, internet and similar systems, the DPAs have relatively lower realization costs of circuit. People commonly think that DPAs are helpful to the modularization of the system, the increase of the efficiency and the system allocation though each DPA increases an extra power conversion stage. When a DPA is employed to provide an electricity, it is easier to accomplish a heat dissipation, has a better effect, and is more reliable while working under a relatively lower temperature than a centralized power architecture could achieve due to that the power of each power source is relatively smaller, the amount of heat generated by the power source is relatively lower, and the heat generated by the power source is uniformly distributed in the system case. Furthermore, relatively the higher the dispersity of the power source, the smaller the range of influence is when the power of source is broken down, and the higher the reliability of the system is.

The above-mentioned DPA can be categorized into two kinds of topologies. One of the topology, as shown in FIG. 1, is a DPA 1 which includes a fore-end AC/DC power supply receiving an AC and generating, e.g., but not limited to, a 48 VDC bus voltage, a DC/DC converter receiving the 48 VDC input voltage and outputting an output voltage selecting from a group consisting of, e.g., but not limited to, 5 VDC, 3.3 VDC and 12 VDC, and a plurality of point of load (POL) converters. To avoid the two-stage power conversion and the degeneration of the combined efficiency, this method is employed to provide the electricity for the main load having relatively higher power consumption disposed on the printed circuit board (PCB). Since the system PCB usually requires several other voltages, these other voltages (e.g., 3.3 VDC, 2.5 VDC and 1.8 VDC as shown in FIG. 1) are generated by a bus voltage selecting from a group consisting of, e.g., but not limited to, 5 VDC, 3.3 VDC and 12 VDC inputting into the plurality of POL converters, POL#1-POL#N. Another kind of topology, as shown in FIG. 2, is a DPA 2 which also includes a fore-end AC/DC power supply receiving an AC and generating, e.g., but not limited to, a 48 VDC bus voltage and an intermediate bus converter (IBC) receiving the 48 VDC input voltage and outputting a bus voltage, e.g., but not limited to, 12 VDC, and the plurality of POL converters, POL#1-POL#N, generating a plurality of DC output voltages (e.g., 5 VDC, 3.3 VDC and 1.8 VDC as shown in FIG. 2). This topology is employed when a relatively higher total power is required (since relatively a higher voltage results in a lower power distribution loss).

As shown in FIG. 3, it is a schematic circuit diagram of a DPA having a DC/DC converter in the prior art. It shows the DPA 1 as shown in FIG. 1, and in which, each of the DC/DC converter and the plurality of POL converters includes a power stage and a control unit. FIG. 4 shows a schematic circuit diagram of a DPA having an intermediate bus converter in the prior art. It shows the DPA 2 as shown in FIG. 2, and in which, each of the IBC and the plurality of POL converters includes a power stage and a control unit.

However, designs for the aforementioned DPA configurations have to be changed to increase the operation efficiency, the heat dissipation efficiency and the power density since the system frequency width of the communication system is relatively higher such that each PCB must be disposed with more elements like ASICs and network processing units such that currently a DPA must meet the requirements of occupying a relatively less space, having a relatively higher efficiency and employing a relatively less elements.

Keeping the drawbacks of the prior arts in mind, and employing experiments and research full-heartily and persistently, the applicant finally conceived a DPA having a centralized control unit.

### SUMMARY OF THE INVENTION

It is therefore an object of the present invention to provide a DPA having a centralized control unit such that the advantages of occupying relatively less space, having relatively higher efficiency and employing relatively less elements are achieved.

According to the first aspect of the present invention, a DPA includes a first converter having a first power stage and a plurality of second converters, each of which has a second power stage coupled to the first converter, and a centralized control unit controlling the first converter and the plurality of second converters.

Preferably, the first converter is one of a DC/DC converter and an intermediate bus converter, and each the second converter is a POL converter.

Preferably, the first converter receives an input voltage and outputs a first output voltage and the plurality of second converters receive the first output voltage and output a plurality of second output voltages.

Preferably, the input voltage is a DC input voltage, the first output voltage is a first DC output voltage, and the plurality of second output voltages are a plurality of second DC output voltages.

Preferably, the centralized control unit executes, e.g., but not limited to, a timing, a tracking and a sequencing functions for each the POL converter and proceeds a telemetry and a computation functions regarding the second output voltage, an output current and an interior temperature for each the POL converter via a unified manipulation of the plurality of POL converters.

Preferably, the centralized control unit executes, e.g., but not limited to, a hot plug, an inrush current limiting and an EMI limiting functions for the DPA.

According to the second aspect of the present invention, a DPA includes a first converter including a centralized control unit and a first power stage, and a plurality of second converters coupled to the first converter, each of which has a second power stage, wherein the centralized control unit controls the first power stage and the plurality of second converters.

Preferably, the centralized control unit executes, e.g., but not limited to, a hot plug, an inrush current limiting and an EMI limiting functions for the DPA via the first converter.

Preferably, the centralized control unit executes, e.g., but not limited to, a timing, a tracking and a sequencing functions for each the second converter and proceeds a telemetry and a computation functions regarding an output voltage, an output current and an interior temperature for each the second converter via a unified manipulation of the plurality of second converters through the first converter.

According to the third aspect of the present invention, a DPA includes a plurality of POL converters outputting a plurality of output voltages, wherein each the POL converter has a first power stage, and a centralized control unit controlling the plurality of POL converters.

Preferably, the DPA further includes a DC/DC converter, wherein the DC/DC converter receives an input voltage, outputs a first output voltage, and includes a second power stage and the centralized control unit, and the plurality of POL converters receive the first output voltage and output a plurality of second output voltages.

Preferably, the DC/DC converter is an independent DC/DC converter, the input voltage is a DC input voltage, the first output voltage is a first DC output voltage, and the plurality of second output voltages are a plurality of second DC output voltages.

Preferably, the centralized control unit executes, e.g., but not limited to, a hot plug, an inrush current limiting and an EMI limiting functions for the DPA via the DC/DC converter.

Preferably, the centralized control unit executes, e.g., but not limited to, a timing, a tracking and a sequencing functions for each the POL converter and proceeds a telemetry and a computation functions regarding the second output voltage, an output current and an interior temperature for each the POL converter via a unified manipulation of the plurality of POL converters through the DC/DC converter.

Preferably, the DPA further includes an IBC receiving an input voltage, outputting a first output voltage and including a second power stage and the centralized control unit, wherein the plurality of POL converters receive the first output voltage and output a plurality of second output voltages.

Preferably, the centralized control unit executes, e.g., but not limited to, a hot plug, an inrush current limiting and an EMI limiting functions for the DPA via the IBC.

Preferably, the centralized control unit executes, e.g., but not limited to, a timing, a tracking and a sequencing functions for each the POL converter and proceeds a telemetry and a computation functions regarding the second output voltage, an output current and an interior temperature for each the POL converter via a unified manipulation of the plurality of POL converters through the IBC.

Preferably, the power architecture further includes a DC/DC converter receiving an input voltage, outputting a first output voltage and including a second power stage, wherein the plurality of POL converters receive the first output voltage and output a plurality of second output voltages.

Preferably, the power architecture further includes an IBC receiving an input voltage, outputting a first output voltage and including a second power stage, wherein the plurality of POL converters receive the first output voltage and output a plurality of second output voltages.

The present invention may best be understood through the following descriptions with reference to the accompanying drawings, in which:

### BRIEF DESCRIPTION OF THE DRAWINGS

FIG. 1 shows a block diagram of a DPA having a DC/DC converter in the prior art;

FIG. 2 shows a block diagram of a DPA having an IBC in the prior art;

FIG. 3 shows a schematic circuit diagram of a DPA having a DC/DC converter in the prior art;

FIG. 4 shows a schematic circuit diagram of a DPA having an IBC in the prior art;

FIGS. 5(a)-5(b) respectively show a schematic circuit diagram of a DPA having a centralized control unit according to the first and the second preferred embodiments of the present invention; and

FIGS. 6(a)-6(b) respectively show a schematic circuit diagram of a DPA having a centralized control unit according to the third and the fourth preferred embodiments of the present invention.

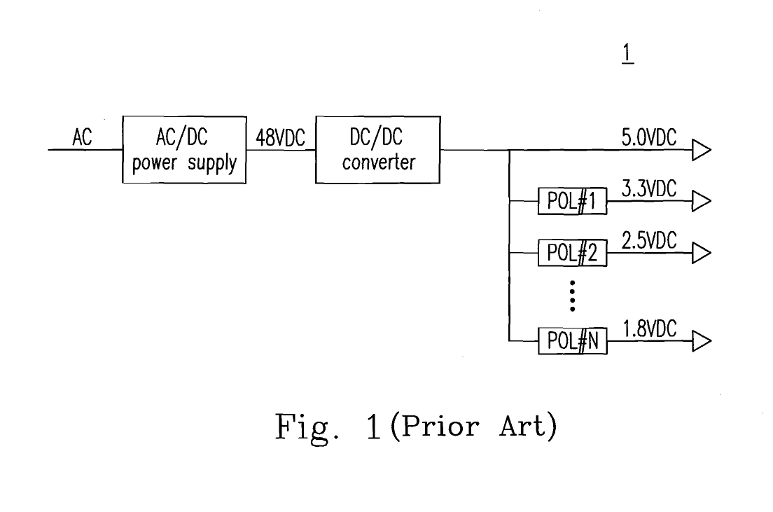

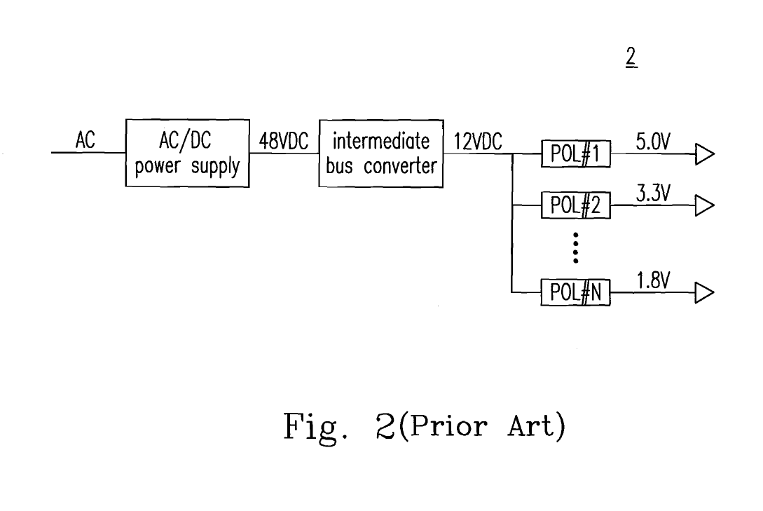

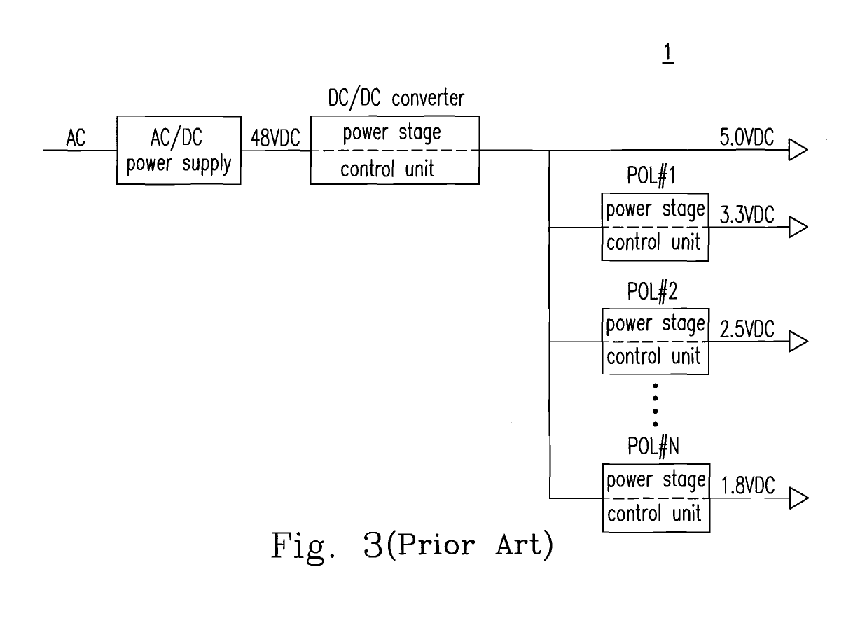

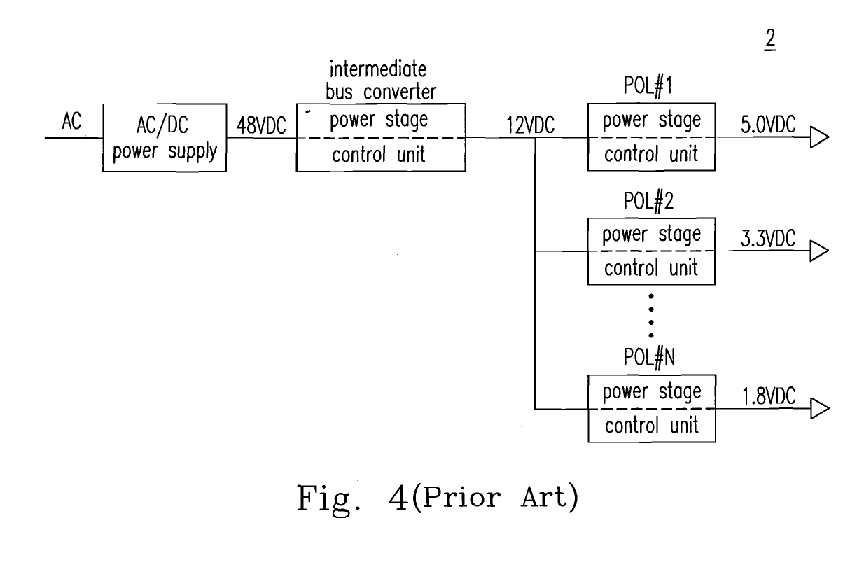

### DETAILED DESCRIPTION OF THE PREFERRED EMBODIMENT

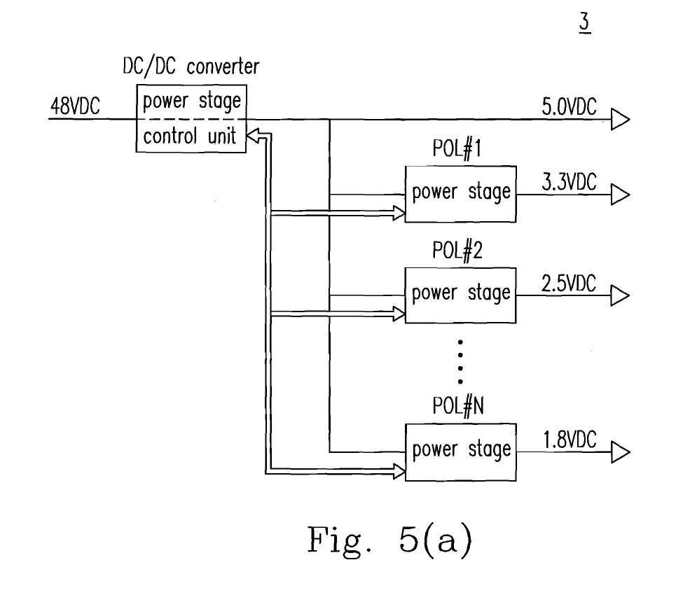

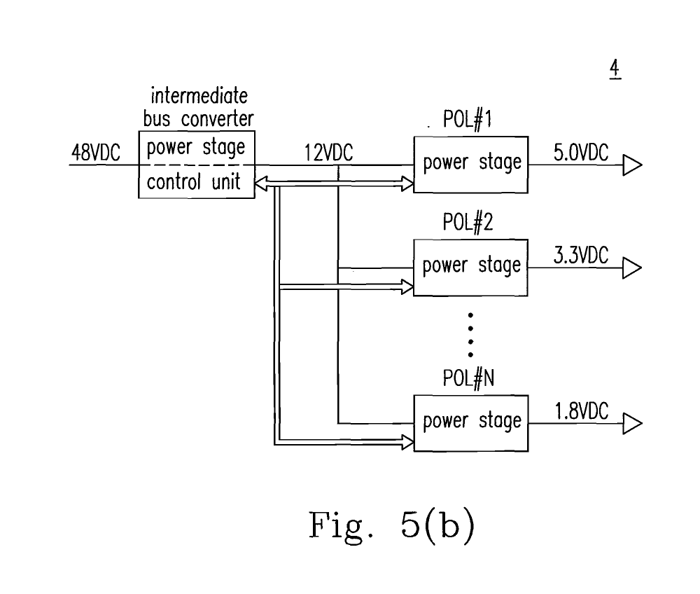

FIG. 5(a) shows a schematic circuit diagram of a DPA having a centralized control unit according to the first preferred embodiment of the present invention. In FIG. 5(a), a DPA 3 includes a DC/DC converter (it could be an independent DC/DC converter) receiving, e.g., but not limited to, a 48 VDC bus voltage and including a (first) power stage and a control unit (a centralized control unit) and a plurality of POL converters POL#1-POL#N. The DC/DC converter of the DPA 3 receives the 48 VDC input voltage and outputs a relatively lower, e.g., but not limited to a 5.0 VDC, output voltage (which is a bus voltage). The output voltage of 5.0 VDC is converted to, e.g., but not limited to 3.3 VDC, 2.5 VDC and 1.8 VDC, output voltages of the plurality of POL converters via a unified manipulation of the plural (second) power stages of the plurality of second converters through the centralized control unit. Each of the POL converters has the second power stage only but doesn't have its own control unit.

FIG. 5(b) shows a schematic circuit diagram of a DPA having a centralized control unit according to the second preferred embodiment of the present invention. In FIG. 5(b), a DPA 4 includes an IBC receiving, e.g., but not limited to, a 48 VDC bus voltage and including a (first) power stage and a control unit (a centralized control unit) and a plurality of POL converters POL#1-POL#N. The IBC of the DPA 4 receives the 48 VDC input voltage and outputs a relatively lower, e.g., but not limited to a 12 VDC, bus voltage. The bus voltage of 12 VDC is converted to, e.g., but not limited to 5.0 VDC, 3.3 VDC and 1.8 VDC, output voltages of the plurality of POL converters via a unified manipulation of the plural (second) power stages of the plurality of POL converters POL#1-POL#N through the centralized control unit. Each of the POL converters only includes the second power stage but not its own control unit.

In the above-mentioned first and second preferred embodiments of the present invention as shown in FIGS. 5(a)-5(b), both the DC/DC converter and the IBC have the centralized control unit, which is used to uniformly manipulate the respective (first) power stage and the plural (second) power stages of the plurality of POL converters POL#1-POL#N. Due to that each of the plurality of POL converters doesn't have its own control unit, though the centralized control unit is more expensive than the control unit of the POL converter in the prior art, but since N control units of the POL converters are omitted, still the total costs of the proposed DPA are dramatically decreased. Besides, the advantages of occupying relatively less space (decreasing N control units of the plurality of POL converters), having relatively higher efficiency (uniformly manipulating via the centralized control unit) and employing relatively less elements (decreasing N control units of the plurality of POL converters) could be achieved since the centralized control unit is used to uniformly manipulate one of the DC/DC converter and the IBC, and the plurality of POL converters. Through a unified manipulation of the plurality of POL converters via the centralized control unit, functions like, e.g., but not limited to, a timing, a tracking and a sequencing for each the POL converter could be executed and functions such as, e.g., but not limited to, a telemetry and a computation regarding the output voltage, an output current (not shown) and an interior temperature (not shown) for each the POL converter, and functions for a hot plug, an inrush current limiting and an EMI limiting (the related apparatuses are not shown) of the proposed DPA could be proceeded. Besides, corresponding changes are easy to follow when the requirements of the designs are happened to be changed such that (e.g., but not limited to) the flexibility of the designs of DPAs like 3 and 4 is dramatically increased.

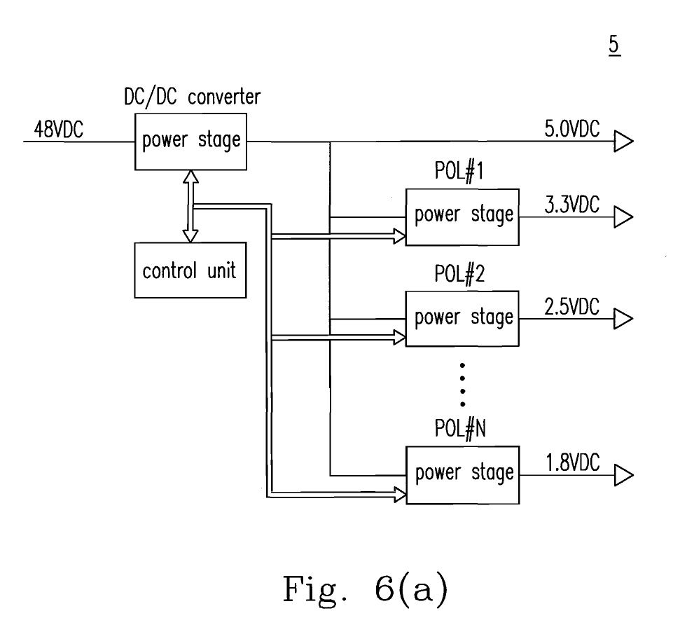

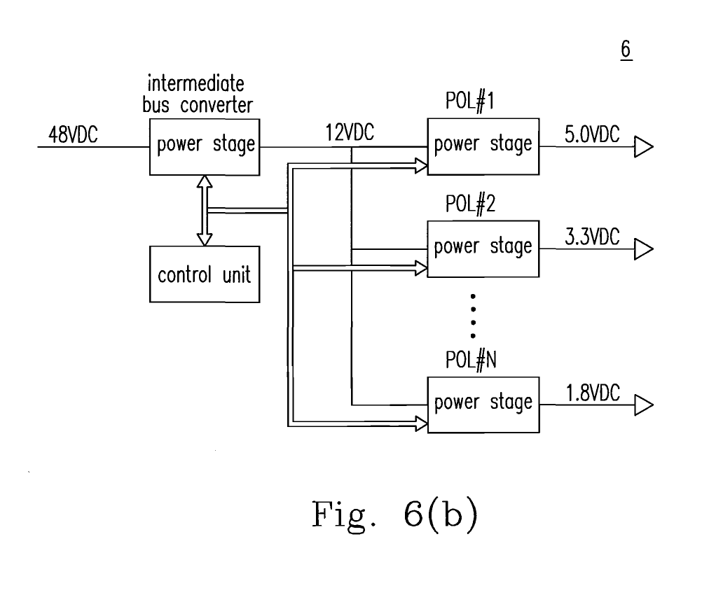

FIG. 6(a) shows a schematic circuit diagram of a DPA having a centralized control unit according to the third preferred embodiment of the present invention. In FIG. 6(a), a DPA 5 includes a control unit (a centralized control unit), a DC/DC converter (it could be an independent DC/DC converter) receiving, e.g., but not limited to, a 48 VDC bus voltage and including a (first) power stage and a plurality of POL converters POL#1-POL#N, each of which has a (second) power stage. Similarly, the DC/DC converter of the DPA 5 receives the 48 VDC input voltage and generates a relatively lower, e.g., but not limited to a 5.0 VDC, output voltage (which is a bus voltage). The output voltage of 5.0 VDC is converted to, e.g., but not limited to 3.3 VDC, 2.5 VDC and 1.8 VDC, output voltages of the plurality of POL converters via the unified manipulation of the plural (second) power stages of the plurality of second converters through the centralized control unit also. Each of the POL converters has the second power stage only but doesn't have its own control unit.

FIG. 6(b) shows a schematic circuit diagram of a DPA having a centralized control unit according to the fourth preferred embodiment of the present invention. In FIG. 6(b), a DPA 6 includes a control unit (a centralized control unit), an IBC receiving, e.g., but not limited to, a 48 VDC bus voltage, outputting a relatively lower, e.g., but not limited to a 12 VDC, bus voltage and including a (first) power stage, and a plurality of POL converters POL#1-POL#N, each of which has a (second) power stage. The received bus voltage of 12 VDC is converted to, e.g., but not limited to 5.0 VDC, 3.3 VDC and 1.8 VDC, output voltages of the plurality of POL converters via a unified manipulation of the plural (second) power stages of the plurality of POL converters POL#1-POL#N through the centralized control units. Each of the POL converters only includes the second power stage but not its own control unit also.

In the aforementioned third and fourth preferred embodiments of the present invention as shown in FIGS. 6(a)-6(b), both the DC/DC converter and the IBC have the centralized control unit, which is used to uniformly manipulate the respective (first) power stage and the plural (second) power stages of the plurality of POL converters POL#1-POL#N. Due to that each of the plurality of POL converters doesn't have its own control unit, though the centralized control unit is more expensive than the control unit of the POL converter in the prior art, but since N control units of the POL converters are omitted, still the total costs of the proposed DPA are dramatically decreased. Besides, the advantages of occupying relatively less space (decreasing N control units of the plurality of POL converters), having relatively higher efficiency (uniformly manipulating via the centralized control unit) and employing relatively less elements (decreasing N control units of the plurality of POL converters) could be achieved since the centralized control unit is used to uniformly manipulate one of the DC/DC converter and the IBC, and the plurality of POL converters. By the same token, through a unified manipulation of the plurality of POL converters via the centralized control unit, functions like, e.g., but not limited to, a timing, a tracking and a sequencing for each the POL converter could be executed and functions such as, e.g., but not limited to, a telemetry and a computation regarding the output voltage, an output current (also not shown) and an interior temperature (not shown neither) for each the POL converter, and functions for a hot plug, an inrush current limiting and an EMI limiting (the related apparatuses are not shown too) of the proposed DPA could be proceeded. Besides, corresponding changes are easy to follow when the requirements of the designs are happened to be changed such that (e.g., but not limited to) the flexibility of the designs of DPAs like 5 and 6 is dramatically increased.

According to the above-mentioned descriptions, a DPA having a centralized control unit is provided such that the advantages of occupying relatively less space, having relatively higher efficiency and employing relatively less elements are achieved.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present invention which is defined by the appended claims.

What is claimed is:

1. A distributed power architecture, comprising:
a first converter having a first power stage; and
a plurality of second converters, each of which has a second power stage coupled to the first converter; and
a centralized control unit controlling the first converter and the plurality of second converters.

2. A power architecture according to claim 1, wherein the first converter is one of a DC/DC converter and an intermediate bus converter, and each the second converter is a point of load (POL) converter.

3. A power architecture according to claim 2, wherein the first converter receives an input voltage and outputs a first output voltage, and the plurality of second converters receive the first output voltage and output a plurality of second output voltages.

4. A power architecture according to claim 3, wherein the input voltage is a DC input voltage, the first output voltage is a first DC output voltage, and the plurality of second output voltages are a plurality of second DC output voltages.

5. A power architecture according to claim 3, wherein the centralized control unit executes a timing, a tracking and a sequencing functions for each the POL converter and proceeds a telemetry and a computation functions regarding the second output voltage, an output current and an interior temperature for each the POL converter via a unified manipulation of the plurality of POL converters.

6. A power architecture according to claim 1, wherein the centralized control unit executes a hot plug, an inrush current limiting and an EMI limiting functions for the distributed power architecture.

7. A distributed power architecture, comprising:
a first converter, comprising:
a centralized control unit; and
a first power stage; and
a plurality of second converters coupled to the first converter, each of which has a second power stage,
wherein the centralized control unit controls the first power stage and the plurality of second converters.

8. A power architecture according to claim 7, wherein the centralized control unit executes a hot plug, an inrush current limiting and an EMI limiting functions for the distributed power architecture via the first converter.

9. A power architecture according claim 7, wherein the centralized control unit executes a timing, a tracking and a sequencing functions for each the second converter and proceeds a telemetry and a computation functions regarding an output voltage, an output current and an interior temperature for each the second converter via a unified manipulation of the plurality of second converters through the first converter.

10. A distributed power architecture, comprising:
a plurality of point of load (POL) converters outputting a plurality of output voltages, wherein each the POL converter has a first power stage; and
a centralized control unit controlling the plurality of POL converters.

11. A power architecture according to claim 10 further comprising a DC/DC converter, wherein the DC/DC converter receives an input voltage, outputs a first output voltage, and comprises a second power stage and the centralized control unit, and the plurality of POL converters receive the first output voltage and output a plurality of second output voltages.

12. A power architecture according to claim 11, wherein the DC/DC converter is an independent DC/DC converter, the input voltage is a DC input voltage, the first output voltage is a first DC output voltage, and the plurality of second output voltages are a plurality of second DC output voltages.

13. A power architecture according to claim 11, wherein the centralized control unit executes a hot plug, an inrush current limiting and an EMI limiting functions for the distributed power architecture via the DC/DC converter.

14. A power architecture according to claim 11, wherein the centralized control unit executes a timing, a tracking and a sequencing functions for each the POL converter and proceeds a telemetry and a computation functions regarding the second output voltage, an output current and an interior temperature for each the POL converter via a unified manipulation of the plurality of POL converters through the DC/DC converter.

15. A power architecture according to claim 10 further comprising an intermediate bus converter receiving an input voltage, outputting a first output voltage and comprising a second power stage and the centralized control unit, wherein the plurality of POL converters receive the first output voltage and output a plurality of second output voltages.

16. A power architecture according to claim 15, wherein the centralized control unit executes a hot plug, an inrush current limiting and an EMI limiting functions for the distributed power architecture via the intermediate bus converter.

17. A power architecture according to claim 15, wherein the centralized control unit executes a timing, a tracking and a sequencing functions for each the POL converter and proceeds a telemetry and a computation functions regarding the second output voltage, an output current and an interior temperature for each the POL converter via a unified manipulation of the plurality of POL converters through the intermediate bus converter.

18. A power architecture according to claim 10 further comprising a DC/DC converter receiving an input voltage, outputting a first output voltage and comprising a second power stage, wherein the plurality of POL converters receive the first output voltage and output a plurality of second output voltages.

19. A power architecture according to claim 10 further comprising an intermediate bus converter receiving an input voltage, outputting a first output voltage and comprising a second power stage, wherein the plurality of POL converters receive the first output voltage and output a plurality of second output voltages.
